(19) United States
(12) Patent Application Publication
(10) Pub. No.: US 2008/0293384 A1
(43) Pub. Date: Nov. 27, 2008

(54) COMMUNICATING A REAL-TIME TEXT RESPONSE

(76) Inventor: Paul Edwin Jones, Apex, NC (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(21) Appl. No.: 11/753,085

(22) Filed: May 24, 2007

(51) Int. Cl. H04L 12/58

(52) U.S. Cl. 455/412.1; 455/466

(57) ABSTRACT

In one embodiment, a method includes receiving a communication from a text telephone via a packet-switched network. The method also includes, automatically and without user intervention, generating a real-time text response to the communication from the text telephone and, automatically and without user intervention, communicating the real-time text response to the text telephone via the packet-switched network for presentation to a user at the text telephone.

### TECHNICAL FIELD OF THE DISCLOSURE

This disclosure relates generally to real-time text communication.

### BACKGROUND OF THE INVENTION

Text telephones are communications devices that can receive or send real-time text. In real-time text communication, real-time text is sent character-by-character as soon as a character is available or with only a slight buffering delay.

### BRIEF DESCRIPTION OF THE DRAWINGS

FIG. 1 illustrates an example system for communicating real-time text responses; and

FIG. 2 illustrates an example method for communicating real-time text responses.

### DESCRIPTION OF EXAMPLE EMBODIMENTS

Overview

In one embodiment, a method includes receiving a communication from a text telephone via a packet-switched network. The method also includes, automatically and without user intervention, generating a real-time text response to the communication from the text telephone and, automatically and without user intervention, communicating the real-time text response to the text telephone via the packet-switched network for presentation to a user at the text telephone.

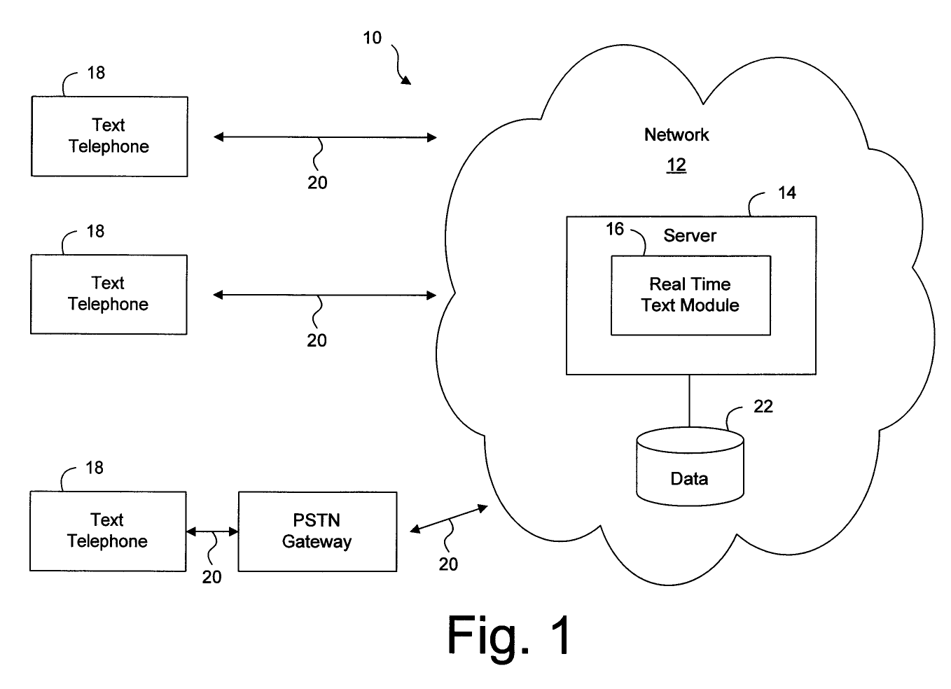

FIG. 1 illustrates an example system 10 for automatically generating a real-time text response. System 10 includes text telephones 18 that communicate with each other via Internet Protocol (IP) network 12. In particular embodiments, IP network 12 is a local area network (LAN), a wireless LAN (WLAN), a wide area network (WAN), a metropolitan area network (MAN), a portion of the Internet, or another IP network 12 or a combination of two or more such networks 12. The present invention contemplates any suitable IP network 12. One or more links 20 couple a text telephone 18 to IP network 12. In particular embodiments, one or more links 20 each include one or more wireline, wireless, or optical links 20. In particular embodiments, one or more links 20 each include a LAN, a WLAN, a WAN, a MAN, a portion of the Internet, a portion of the Public Switched Telephone Network (PSTN), or another link 20 or a combination of two or more such links 20. In particular embodiments, one or more links 20 are each analog links 20. The present invention contemplates any suitable links 20 coupling text telephone 20 to IP network 12.

Text telephone 18 enables users at text telephone 18 to communicate with each other and other endpoints through real-time text. As an example and not by way of limitation, a text telephone 18 may include a legacy telephone, a telephone having voice over Internet Protocol (VoIP) capabilities, a mobile telephone (which may, but need not, have VoIP capabilities), a personal digital assistant (PDA), a computer system, a textphone (which may be referred to as a telecommunication device for the deaf (TDD) or teletypewriter (TTY)), or another text telephone 18 or a combination of two or more such text telephones 18. A legacy telephone may be a landline telephone set that may generate dual-tone multifrequency (DTMF) signals in response to a user pressing keys on the telephone set. A telephone having VoIP capabilities may be a wireless or wireline Internet Protocol (IP) telephone that may generate data providing DTMF signals in response to a user pressing keys on the telephone or otherwise providing input to the telephone. A mobile telephone may be a wireless telephone capable of connecting to an 802.11 or other WLAN, a cellular telephone network, or both. A computer system may be a notebook computer system capable of connecting to an LAN, a WLAN, or both. To communicate with one or more other users, a user at a computer system coupled to IP network 12 may access a telephone application on the computer system, a communication client at the computer system, a web browser on the computer system capable of accessing a web page or website providing communication functionality, or an application on the computer system supporting e-mail (such as, for example, MICROSOFT OUTLOOK or a similar application) including a communication form. The present invention contemplates any suitable text telephone 18.

In particular embodiments, a text telephone 18 is a TDD coupled to a gateway. As an example and not by way of limitation, the TDD may communicate with real-time text module 16 via server 14. Real-time text module 16 may receive a communication from the TDD, automatically generate a real-time text response to the communication, and communicate the real-time text response to the TDD. The TDD may be coupled to a gateway coupled to IP network 12 any may communicate with real-time text module 16 during a customer-service call. Real-time text module 16 may receive a communication from the TDD and, automatically and without user intervention, generate a real-time text response providing a menu of options to the TDD for presentation to a user. The user may input into the TDD a real-time text response corresponding to a menu selection by the user.

IP network 12 includes a server 14. In particular embodiments, server 14 includes one or more servers 14. In particular embodiments, server 14 is a hardware, software, or embedded logic component or a combination of two or more such components residing at one or more servers in IP network 12. In particular embodiments, server 14 includes or has access to one or more databases, file systems, or storage devices capable of storing data 22. Data 22 may include, for example, one or more files containing data used to generate responses or scripts for responses. The present invention contemplates any suitable server.

Server 14 includes a real-time text module 16. In particular embodiments, real-time text module 16 is a hardware, software, or embedded logic component or a combination of two or more such components providing real-time text functionality. In particular embodiments, real-time text module 16 resides at server 14. In particular embodiments, real-time text module 16 resides elsewhere in IP network 12. As an example and not by way of limitation, real-time text module 16 may reside at a server apart from but accessible to server 14 dedicated to certain processing functionality. Although particular arrangements among a particular server 14 and real-time text module 16 are described and illustrated, the present invention contemplates any suitable arrangement among any suitable server 14 and any suitable real-time text module 16.

Real-time text involves communicating text character-by-character as soon as a character becomes available or with a slight delay for buffering. As an example and not by way of limitation, a user at a text telephone 18 may enter real-time using a keyboard, using hand-writing recognition, voice recognition, or another suitable input method. In addition or as an alternative, software may generate real-time text. Real-time text may be used alone or in combination with one or more other conversational facilities, such as voice, video, or both. In particular embodiments, the communication of real-time text via a packet-switched network involves the communication of only a few characters in any one packet.

Real-time text module 16 provides real-time text functionality. In particular embodiments, real-time text module 16 provides interactive voice recognition (IVR) functionality using real-time text. As an example and not by way of limitation, real-time text module 16 may generate a real-time text response that provides a menu of options for real-time text selection by a user at a text telephone 18. The menu may include call-handling options, information options, or other options, according to particular needs. Selection of a call-handling option may transfer the call to a particular extension, terminate the call, or cause another call-handling event to occur. Real-time text module 16 may receive a real-time text reply from text telephone 18 in response to a real-time text response generated by real-time text module 16. Real-time text module 16 may forward the real-time text reply for processing according to information in the real-time text reply. As an example and not by way of limitation, real-time text module 16 may receive a real-time text reply from a text telephone 18 requesting a transfer of funds from one bank account to another. Real-time text module 16 may cause one or more processes to execute according to the information in the real-time text reply to initiate the transfer.

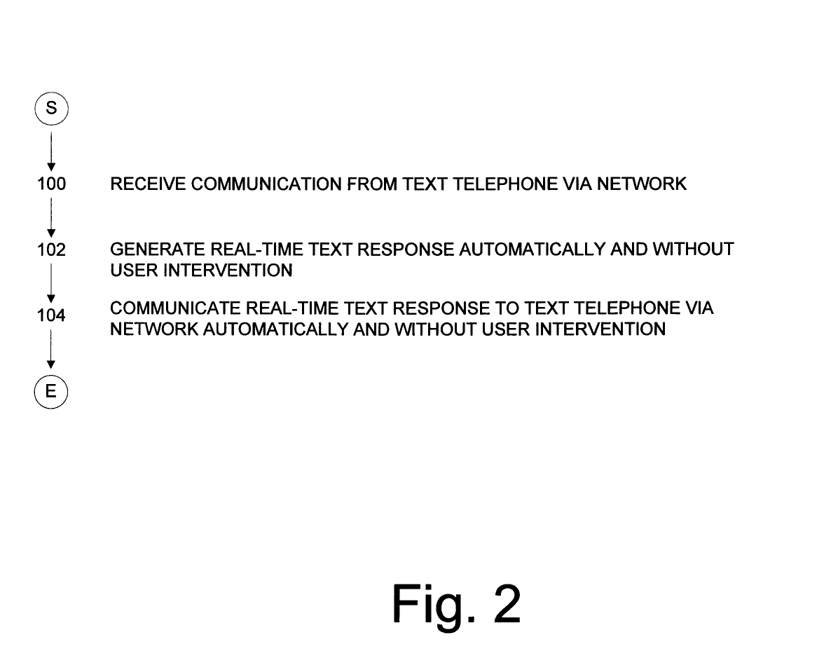

FIG. 2 illustrates an example method for communicating real-time text responses. The method begins at step 100, where real-time text module 16 receives a communication from a text telephone 18 via IP network 12. At step 102, real-time text module 16, automatically and without user intervention, generates a real-time text response to the communication from text telephone 18. As an example and not by way of limitation, the real-time text response to the communication may include information requested by a user at text telephone 18. In addition or as an alternative, the real-time text response may include a request for input from the user at text telephone 18. At step 104, real-time text module 16, automatically and without user intervention, communicates the real-time text response to the text telephone 18 via a IP network 12 for presentation to the user at text telephone 18. Although particular steps in the method illustrated in FIG. 2 have been illustrated and described as occurring in a particular order, the present invention contemplates any suitable steps of the method illustrated in FIG. 2 occurring in any suitable order.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. An apparatus comprising:
one or more processors; and
a memory coupled to the processors comprising instructions executable by the processors, the processors operable when executing the instructions to:
receive a communication from a text telephone via a packet-switched network;
automatically and without user intervention, generate a real-time text response to the communication from the text telephone; and
automatically and without user intervention, communicate the real-time text response to the text telephone via the packet-switched network for presentation to a user at the text telephone.

2. The apparatus of claim 1, wherein the text telephone comprises a legacy telephone coupled to a gateway coupled to an Internet Protocol (IP) network, the legacy telephone comprising telecommunications device for the deaf (TDD) functionality.

3. The apparatus of claim 1, wherein the text telephone is a mobile phone.

4. The apparatus of claim 1, wherein the communication from the text telephone to the apparatus is an Internet Protocol (IP) communication.

5. The apparatus of claim 1, wherein the real-time text response prompts a user at the text telephone to provide real-time text input.

6. The apparatus of claim 1, wherein the real-time text response provides a menu of options for real-time text selection by a user at the text telephone.

7. The apparatus of claim 1, wherein the processors are further operable when executing the instructions to:
receive a real-time text reply from the text telephone in response to the real-time text response; and
communicate the real-time text reply for processing according to information in the real-time text reply.

8. The apparatus of claim 1, wherein the processors are further operable when executing the instructions to:
receive a real-time text reply from the text telephone in response to the real-time text response; and
trigger one or more call-handling events according to information in the real-time text reply.

9. A method comprising:
receiving a communication from a text telephone via a packet-switched network;
automatically and without user intervention, generating a real-time text response to the communication from the text telephone; and
automatically and without user intervention, communicating the real-time text response to the text telephone via the packet-switched network for presentation to a user at the text telephone.

10. The method of claim 9, wherein the text telephone comprises a legacy telephone coupled to a gateway coupled to an Internet Protocol (IP) network, the legacy telephone comprising telecommunications device for the deaf (TDD) functionality.

11. The method of claim 9, wherein the text telephone is a mobile phone.

12. The method of claim 9, wherein the communication from the text telephone is an Internet Protocol (IP) communication.

13. The method of claim 9, wherein the real-time text response prompts a user at the text telephone to provide real-time text input.

14. The method of claim 9, wherein the real-time text response provides a menu of options for real-time text selection by a user at the text telephone.

15. The method of claim 9, further comprising:
receiving a real-time text reply from the text telephone in response to the real-time text response; and
communicating the real-time text reply for processing according to information in the real-time text reply.

16. The method of claim 9, further comprising:
receiving a real-time text reply from the text telephone in response to the real-time text response; and
triggering one or more call-handling events according to information in the real-time text reply.

17. Logic encoded in one or more tangible media for execution and when executed operable to:
receive a communication from a text telephone via a packet-switched network;
automatically and without user intervention, generate a real-time text response to the communication from the text telephone; and
automatically and without user intervention, communicate the real-time text response to the text telephone via the packet-switched network for presentation to a user at the text telephone.

18. The logic of claim 17, wherein the text telephone comprises a legacy telephone coupled to a gateway coupled to an Internet Protocol (IP) network, the legacy telephone comprising telecommunications device for the deaf (TDD) functionality.

19. The logic of claim 17, wherein the real-time text response prompts a user at the text telephone to provide real-time text input.

20. The logic of claim 17, wherein the real-time text response provides a menu of options for real-time text selection by a user at the text telephone.

21. The logic of claim 17, wherein, when executed, further operable to:
receive a real-time text reply from the text telephone in response to the real-time text response; and
communicate the real-time text reply for processing according to information in the real-time text reply.

22. The logic of claim 17, wherein, when executed, further operable to:
receive a real-time text reply from the text telephone in response to the real-time text response; and
trigger one or more call-handling events according to information in the real-time text reply.
